(19) United States
(12) Patent Application Publication
(10) Pub. No.: US 2023/0129662 A1
(43) Pub. Date: Apr. 27, 2023

(54) A METHOD TO DEINK PLASTIC MATERIAL

(71) Applicant: Universiteit Gent, Gent (BE)

(72) Inventors: Steven De Meester, Brakel (BE); Martijn Roosen, Kortrijk (BE); Sibel Ügdüler, Merelbeke (BE)

(21) Appl. No.: 17/907,717

(22) PCT Filed: Apr. 1, 2021
(86) PCT No.: PCT/EP2021/058652

§ 371 Date: Sep. 29, 2022

(30) Foreign Application Priority Data
Apr. 2, 2020 (EP) 20167745.7

(51) Int. Cl. C09D 9/04; C11D 1/12; C25F 5/00

(52) U.S. Cl. CPC C09D 9/04; C11D 1/12; C25F 5/00

(57) ABSTRACT

This disclosure relates to a method to deink plastic material comprising or provided with ink. The method comprises the step of contacting the plastic material with an oxidizing inorganic acid having a standard electrode potential of at least 0 V. The disclosure also relates to a method to delaminate and deink plastic material by contacting the plastic material with an oxidizing inorganic acid and with a short chain or medium chain fatty acid. Furthermore, the disclosure relates to an installation to deink or to delaminate and deink plastic material.

### CROSS-REFERENCE TO RELATED APPLICATIONS

This application is a national phase entry under 35 U.S.C. § 371 of International Patent Application PCT/EP2021/058652, filed Apr. 1, 2021, designating the United States of America and published as International Patent Publication WO 2021/198437 A1 on Oct. 7, 2021, which claims the benefit under Article 8 of the Patent Cooperation Treaty to European Union Patent Application Serial No. 20167745.7, filed Apr. 2, 2020.

### TECHNICAL FIELD

This disclosure relates to a method to deink plastic material, for example, plastic waste. The disclosure also relates to a method to delaminate and deink plastic material. Furthermore, the disclosure relates to an installation to deink plastic material and to an installation to delaminate and deink plastic material.

### BACKGROUND

Plastic packaging is abundantly used in today's prosperous society. Many types of plastics are currently produced for a broad range of applications. Bottles, for instance, can be produced from different materials such as polyethylene terephthalate (PET), polyethylene (PE) or polypropylene (PP) for both food and non-food applications. Regarding plastic bottles, a well-organized collecting and recycling system already exists in most European countries either via a deposit system (e.g., Germany) or via separated curbside collection (e.g., Belgium). Beside bottles, trays, pots and films are extensively produced to be used in household packaging. In most countries such as among others Belgium, the collection and recycling rates for these packaging materials are still relatively low compared to those for plastic bottles. In response to this, in many countries the source separation systems are expanding to include all types of plastic packaging.

In European countries, these plastics are currently most commonly recovered through open-loop mechanical recycling processes (Reference 1). Nevertheless, contaminations from both the production and use phase adversely affect the quality of recycled plastics. This can be caused by non-intentionally added compounds such as odorous constituents, degradation products or by intentionally added compounds such as inks or additives. The presence of these contaminations impedes re-use of these plastics in high-value applications. Especially, ink negatively affects the optical and physical properties of recycled plastic films. A mix of inks with different colors results in dark-colored pellets after extrusion, therefore the mechanically recycled plastics are only suitable for ‘downcycled’ products (Reference 1). It is also stated that the presence of ink causes recycled films to be less stiff, weaker, and denser than the original material. Furthermore, the processing or reprocessing of plastic material such as plastic waste may result in a rancid odor or rancid odors during or after processing or reprocessing (Reference 1, Reference 2). During the processing or reprocessing, residual ink can also decompose and produce gases causing reduced physical properties of a raw material (Reference 3).

Multilayer plastic packaging causes some additional recycling problems due to the large variety of materials used for each layer and their differences in processing properties (Reference 1). As the different layers are in general not very compatible, the use of compatibilizers is necessary to enhance the blending of the different polymers during mechanical recycling. However, compatibilizers are still limitedly used in industry and more research is still necessary to make the use of these compatibilizers feasible from a technical and economical perspective (Reference 1).

Water-based liquid solutions comprising surfactants are known in the art to deink plastics (EP2832459 and EP1419829). Although water-based liquid solutions are easy to handle from safety perspective, treatments using such solutions are typically not able to deink all types of inks and/or all types of plastic films on the current market. These treatments usually work well on post-consumer and industrial film waste streams with well-defined compositions if the ink is on top of the monolayer or multilayer structure. However, a post-consumer waste stream typically comprises a mix of monolayer and multilayer films. For some plastic waste, the ink is between two layers. Especially for plastic films used in direct contact with food, the ink is usually covered by one or more layers in order to prevent leaching.

DE19651571 describes a method to recycle plastic material using ethyl acetate as extractant. This method only works for plastic material having ink on top of the monolayer or multilayer structure. This means that this method is not suitable to deink real (post-consumer) waste streams comprising plastic material having an ink layer protected by one or more polymer layers. For food-contact packaging material the ink layer is usually protected by one or more polymer layers in order to prevent any leaching. In addition, this method using ethyl acetate as extractant does not work to deink all type of inks, for example, inks that do not dissolve, for example, because they are cross-linked. In particular, a method using ethyl acetate does not work to deink UV-based inks even if they are on top of a monolayer or multilayer structure. UV-based inks are frequently used in packaging material since they offer many benefits such as lightfastness, resistance to smearing, glossiness and/or sharp contracts.

Deinking of monolayer or multilayer plastic material, for example, monolayer or multilayer plastic waste remains challenging and there is a need for improved methods to delaminate and deink plastic material.
Reference 1: Horodytska, O., Valdes, F. J. & Fullana, A. Plastic flexible films waste management—A state of art review. Waste Management 77, 413-425 (2018).
Reference 2: Gecol, H., Scamehorn, J. F., Christian, S. D., Grady, B. P. & Riddell, F. E. Deinking of water-based ink printing from plastic film using nonionic surfactants. Journal of Surfactants and Detergents 5, 363-374 (2002).
Reference 3: Gecol, H., Scamehorn, J. F., Christian, S. D. & Riddell, F. E. Use of surfactants to remove solvent-based inks from plastic films. Colloid and Polymer Science 281, 1172-1177 (2003).

### BRIEF SUMMARY

Provided is a method to deink plastic material such as plastic waste avoiding the drawbacks of the prior art.

Also provided is a method to delaminate and deink plastic material.

Further provided is a method that allows to deink or to delaminate and deink a wide variety of plastic material having different types of inks and/or including different types of multilayer plastic films, plastic material having ink on an outer surface as well as plastic material having ink covered by one or more layers, for example, one or more polymer layers.

Still further provided is a method to deink or to delaminate and deink plastic material without causing neither dissolution nor degradation of the main plastic components of the polymer material.

Also provided is a method to deink or to delaminate and deink plastic material that is efficient in removing annoying odors.

Further provided is a method that allows removing any type of inks from plastic material such as solvent-based inks, water-based inks and UV-based inks, either from monolayer or from multilayer plastic material.

Also provided is an economically viable method to deink plastic material or to delaminate and deink plastic material, in particular, plastic waste.

Further provided is an installation to deink or to delaminate and deink plastic material, in particular, plastic waste.

According to a first aspect of this disclosure a method to deink plastic material, for example, plastic waste, is provided. The method comprises the steps of:
providing plastic material comprising or provided with an ink selected from the group comprising nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, (phenolic) modified rosin based resins, alkyd based resins and any combination thereof;
contacting the plastic material with an oxidizing inorganic acid having a standard electrode potential of at least 0 V; and
separating the thus obtained plastic material from the oxidizing inorganic acid.

The method according to this disclosure does not require the presence of an organic solvent or surfactant. In particular, the contacting of the plastic material with the oxidizing inorganic acid does not require the presence of an organic solvent or the presence of a surfactant.

By bringing the plastic material in contact with the oxidizing inorganic acid as described above, the plastic material is deinked.

While not intending to be bound by any theory, the oxidizing inorganic acid allows to oxidize and/or hydrolyze the inks. The oxidizing inorganic acid allows, for example, to oxidize inks, for example, inks comprising nitrocellulose based resins and/or to hydrolyze inks, for example, cross-linked structures such as acrylates, polyurethane and nitrocellulose.

Experimental results confirmed that the method according to this disclosure results in deinking of plastic materials comprising or provided with different types of inks or with combinations of different types of inks.

The method according to this disclosure allows to deink plastic material comprising or provided with solvent-based inks as, for example, inks comprising nitrocellulose based resins, polyurethane based resins, polyvinylchloride based resins, ethyl cellulose based resins, cellulose acetate propionate based resins, cellulose acetate butyrate based resins, polyvinyl butyral based resins, polyacrylate based resins, polyamide based resins, and combinations thereof.

The method according to this disclosure also allows to deink plastic material comprising or provided with water-based inks as, for example, inks comprising acrylate based resins, maleics based resins or combinations thereof.

The method according to this disclosure also allows to deink plastic material comprising or provided with offset inks as, for example, modified rosin resins, in particular, phenolic modified rosin resins, alkyd based resins and combinations thereof.

The method according to this disclosure also allows to deink plastic material comprising or provided with ultraviolet curable (UV) and/or electron beam (EB) curable resins as, for example, acrylate based resins, for example, epoxy acrylate based resins.

An important advantage of the method according to this disclosure is that it allows to deink plastic material comprising or provided with different types of inks, for example, with solvent-based inks, water based inks, offset inks, UV and/or EB curable inks and any combination thereof.

Deinking can be further improved by applying shear on the plastic material while or after contacting the plastic material with the oxidizing inorganic acid. Shear can be applied by any method known in the art, for example, by stirring, mixing or agitating. Any type of stirring, mixing or agitating known in the art can be considered. For the purpose of this disclosure the terms ‘stir,’ ‘mix’ and ‘agitate’ can be used interchangeably.

An example of stirring comprises stirring in a continuous stirred tank reactor (CSTR) using a rotating agitator with a rotation speed of, for example, at least 100 rpm (revolutions per minute), at least 250 rpm, at least 300 rpm or at least 500 rpm. Alternatively or additionally, other methods to induce shear can be considered as well.

In preferred methods, the plastic material is reduced in size, preferably before being contacted with the oxidizing inorganic acid. The reduction in size can be obtained by any technique known in the art, for example, by milling, shredding, grinding and/or comminuting. The plastic material is preferably reduced in size to obtain plastic material having a sieve diameter between 0.01 cm and 20 cm, for example, between 0.01 cm and 10 cm or between 0.1 cm and 4 cm. The term ‘sieve diameter’ refers to the size of a sieve opening (the width of a square aperture) through which a particle will pass.

The method to deink according to this disclosure may comprise a continuous or discontinuous (batch) process. In a continuous process the plastic material, the oxidizing inorganic acid or both the plastic material and the oxidizing inorganic acid can be continuously introduced. In preferred methods, the oxidizing inorganic acid is reintroduced to contact the plastic material. The oxidizing inorganic acid is for example, reintroduced after being separated from the plastic material in the separating step, to contact the plastic material in the contacting step by way of a looping system.

A particular method according to this disclosure comprises the following steps:
providing plastic material comprising or provided with an ink selected from the group comprising nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, (phenolic) modified rosin based resins, alkyd based resins and any combination thereof;
reducing the polymer material in size to obtain plastic material having a sieve diameter between 0.01 cm and 20 cm, for example, between 0.01 cm and 10 cm or between 0.1 cm and 4 cm;
contacting the plastic material with an oxidizing inorganic acid having a standard electrode potential of at least 0 V while applying shear to the plastic material; and
separating the thus obtained plastic material from the oxidizing inorganic acid.

One expects that the deinking will improve by increasing the amount of oxidizing inorganic acid when contacting the plastic material with the oxidizing inorganic acid. Contrary to these expectations, it was surprisingly found that a higher loading of plastic material in the contacting step (i.e., a higher amount of plastic material per volume of oxidizing inorganic acid) results in an improved deinking.

For the purpose of this disclosure, the loading of the plastic material is expressed as the volume of the plastic material (Vₚₘ) over the volume of the oxidizing inorganic acid

$$( {V}_{i n org . acid} ) : \frac{{V}_{p m}}{{V}_{inorg . acid}} .$$

For the purpose of this disclosure an improved deinking refers to either obtaining faster deinking (higher deinking rate) and/or obtaining a higher degree of deinking (higher % of deinked material).

Although applicant does not want to be bound by any theory, it is assumed that the positive effect on the deinking using a high loading of plastic per volume of oxidizing inorganic acid is the result of the increased mutual contact between plastic material, in particular, when shear is applied to the plastic material, for example, when the plastic material and the oxidizing inorganic acid is stirred. Due to the increased mutual contact between plastic material, the friction between plastic material is increased. The term ‘friction’ refers to the force of rubbing two materials or two faces against one another.

In preferred methods of this disclosure, during the contacting of the plastic material with the oxidizing inorganic acid, the plastic material and the oxidizing inorganic acid are present in amounts so that the volume of the plastic material (Vₚₘ) over the volume of the oxidizing inorganic acid (V_{inorg. acid}) is ranging between 0.1 and 10:

$$0.1 < \frac{{V}_{p m}}{{V}_{i n org . acid}} < 10$$

More preferably, during the contacting of the plastic material with the oxidizing inorganic acid, the plastic material and the oxidizing inorganic acid are present in amounts so that the volume of the plastic material (Vₚₘ) over the volume of the oxidizing inorganic acid (V_{inorg. acid}) is ranging between 0.5 and 2.5

$$( 0.5 < \frac{{V}_{p m}}{{V}_{i n org . acid}} < 2.5 )$$

or between or between 0.8 and 1.2

$$( 0.8 < \frac{{V}_{p m}}{{V}_{i norg . acid}} < 1 \text{.2} ) .$$

The volume of the plastic material (Vₚₘ) over the volume of the oxidizing inorganic acid (V_{inorg. acid}) is, for example, equal to 1

$$( \frac{{V}_{p m}}{{V}_{i n org . acid}} = 1 ) .$$

Preferably, the plastic material and the oxidizing inorganic acid are introduced in a container to allow contacting of the plastic material with the oxidizing inorganic acid. The plastic material and the oxidizing inorganic acid are thereby forming a mixture. Preferably, the ratio of the volume of the plastic material (Vₚₘ) in the container over the volume of the oxidizing inorganic acid in the container (V_{acid}) is ranging between 0.1 and 10, more preferably between 0.5 and 2.5 or between 0.8 and 1.2.

Deinking can be further improved by applying shear on the plastic material introduced in the container, preferably on the mixture of the plastic material and the oxidizing inorganic acid.

In preferred methods, the plastic material is reduced in size, preferably before being introduced in the container and/or before being contacted with the oxidizing inorganic acid. The reduction in size can be obtained by any technique known in the art, for example, by milling, shredding, grinding and/or comminuting. The plastic material is preferably reduced in size to obtain plastic material having a sieve diameter between 0.01 cm and 20 cm, for example, between 0.01 cm and 10 cm or between 0.1 cm and 4 cm.

As plastic material, any type of plastic material including plastic waste can be considered. The main target plastic material comprises polyolefin based material such as, for example, polyethylene (PE) (including low-density polyethylene (LDPE) and high-density polyethylene (HDPE)) and polypropylene (PP). However, the method according to this disclosure is also suitable for other plastic materials such as polyethylene terephthalate (PET), polyurethane (PU), polyamide (PA), polystyrene (PS), polycarbonate (PC), ethylene vinyl alcohol (EVOH), ethylene vinyl acetate (EVA), polyvinyl chloride (PVC) or copolymers or combinations thereof.

Plastic material also comprises plastic waste, for example, waste flows comprising polyolefin based material such as PE or PP, either rigid or non-rigid (films), such waste flows are sometimes referred to as DKR 310 (plastic films), DKR 321 (polyolefin plastic bottles), DKR 323 (mixed polyolefin items), DKR 323-2 (flexible polyolefin items), DKR 324 (polypropylene) and DKR 329 (polyethylene). The method according to this disclosure is also suitable for plastic waste comprising, for example, PET, PU, PA, PS, PC, EVOH, EVA, PVC or copolymers or combinations thereof.

Plastic material may comprise monolayer material or multilayer material comprising multiple layers of plastic films.

Examples of monolayer material comprise polyethylene (PE) and polypropylene (PP) films.

Examples of multilayer material comprise PE/PET, PE/EVOH/PET, PE/PA, PP/PP, PP/PE/PP. Multilayer material may also comprise a metal or metallized layer such as an aluminum layer or an aluminum-based layer. An example of a multilayer comprising a metal layer is PE/Al/PET.

The plastic material such as the plastic waste may comprise contaminants and/or dirt. Contaminants refer to all the components of the plastic material that are not part of the polymer structure. Contaminants comprise, for example, additives, coatings, such as barrier coatings, metal coatings or biocoatings, adhesives, inks and labels such as plastic labels or paper labels. Dirt refers to impurities that adhere to the plastic material during their life cycle such as dust, soil, grease and organic waste.

Plastic waste may comprise post-industrial plastic waste and post-consumer plastic waste. Post-industrial plastic waste includes material that is used or produced in a manufacturing process and comprises, for example, films such as stretch films. Post-industrial plastic waste usually comprises homogeneous material, comprising a single plastic type or of a limited number of plastic types and is usually clean.

Post-consumer plastic waste includes material that has already been used by the end user and comprises, for example, bottles, trays, films, packaging material and household items. Post-consumer plastic waste usually comprises a mixture of different polymer materials that might be highly contaminated and dirty. The polymer material possibly suffered from degradation during service life.

The plastic material such as the plastic waste may comprise or be provided with different types of inks such as solvent-based inks, water-based inks and UV-based inks and may comprise a combination of different types of inks. The inks can be applied on top of the plastic material or between different plastic layers of a multilayer structure. Furthermore, the inks can be embedded in or covered with a layer, such as a polymer based layer, a varnish, or barrier layer. The inks can be cross-linked.

The main ingredients of inks are pigments, dyes, binders and additives, for example, surfactants and/or solubilizers.

Pigments (organic or inorganic) or dyes give color and opacity to the ink and may influence the fluidity of the ink. Binders, usually low-molecular-weight polymeric resins, disperse the pigments and retain them on the plastic surface after printing. The carrier is a liquid, providing fluidity and allowing the transfer of the ink from the printing system to the substrate. Additives in the ink may, for example, comprise waxes, surfactants, drying agents and antioxidizing agents.

The term ‘inorganic acid’ refers to all acidic compounds that originate from an inorganic (or mineral) source. In contrast to organic acids, inorganic acids do not comprise covalent carbon-hydrogen bond or bonds.

The inorganic acid used in the method according to this disclosure has preferably a minimum oxidation potential, i.e., a minimum standard electrode potential. Preferably, the inorganic acid has a standard electrode potential of at least 0 V. More preferably, the inorganic acid used in the method according to this disclosure has an electrode potential of at least 0.2 V, an electrode potential 0.5 V or an electrode potential of at least 1 V. Inorganic acids having a high standard electrode potential are preferred.

For the purpose of this disclosure, inorganic acids having a standard electrode potential of at least 0 V are referred to as oxidizing inorganic acids.

Theoretically, all Brønsted acids have a certain oxidation potential, since their acidic proton can be reduced to hydrogen gas. The capacity of an acid to have oxidation potential and thus to act as an oxidizing agent can be expressed by the standard electrode potential. The higher the standard electrode potential, the higher the capacity to act as an oxidizing agent.

Some examples of inorganic acids with their standard electrode potential are given below.

Phosphoric acid: H₃PO₄(aq)+2H⁺+2e⁻ [symbol] H₃PO₃(aq)+H₂O (−0.276V)
Sulfuric acid: SO₄²⁻+4H⁺+2e⁻ [symbol] SO₂(aq)+2H₂O (+0.17V)
Arsenic acid: H₃AsO₄(aq)+2H⁺+2e⁻ [symbol] H₃AsO₃(aq)+H₂O (+0.56V)
Nitric acid: NO³⁻(aq)+2H⁺+e⁻ [symbol] NO₂(g)+H₂O (+0.80V)
Perchloric acid: ClO₄⁻+2H⁺+2e⁻ [symbol] ClO₃⁻+H₂O (+1.20V).

Within the context of this disclosure, sulfuric acid, arsenic acid, nitric acid, and perchloric acid are considered as oxidizing inorganic acids whereas phosphoric acid is not considered as an oxidizing inorganic acid.

Preferred inorganic acids used in the method according to this disclosure are acids containing oxygen (oxyacids). Such inorganic acids usually have a higher oxidation potential.

Preferred examples of inorganic acids for use in the method according to this disclosure comprise HNO₃, H₂SO₄, HClO₄, H₂CrO₄, H₂SeO₄, HMnO₄, HTcO₄, HReO₄, H₃PO₄, H₃AsO₄, H₂TeO₄, HBrO₄ and HIO₄.

In preferred methods of this disclosure, the inorganic oxidizing acid is present in a concentration of at least at least 20 wt %. More preferably, the inorganic oxidizing acid is present in a concentration of at least 40 wt %, at least 50 wt %, at least 60 wt %, at least 80 wt %, at least 90 wt % or at least 95 wt %.

In a first example, the concentration of the inorganic acid is 20 wt % and the plastic material and the oxidizing inorganic acid are present in amounts so that the volume of the plastic material (Vₚₘ) over the volume of the oxidizing inorganic acid (V_{inorg. acid}) is ranging between 0.1 and 10, for example, ranging between 0.5 and 2.5 or between 0.8 and 1.2.

In another example, the concentration of the inorganic acid is 50 wt % and the plastic material and the oxidizing inorganic acid are present in amounts so that the volume of the plastic material (Vₚₘ) over the volume of the oxidizing inorganic acid (V_{inorg. acid}) is ranging between 0.1 and 10, for example, ranging between 0.5 and 2.5 or between 0.8 and 1.2.

In a further example, the concentration of the inorganic acid is 50 wt % and the plastic material and the oxidizing inorganic acid are present in amounts so that the volume of the plastic material (Vₚₘ) over the volume of the oxidizing inorganic acid (V_{inorg. acid}) is ranging between 0.1 and 10, for example, ranging between 0.5 and 2.5 or between 0.8 and 1.2.

In still a further example, the concentration of the inorganic acid is 50 wt % and the plastic material and the oxidizing inorganic acid are present in amounts so that the volume of the plastic material (Vₚₘ) over the volume of the oxidizing inorganic acid (V_{inorg. acid}) is ranging between 0.1 and 10, for example, ranging between 0.5 and 2.5 or between 0.8 and 1.2.

The concentration of the oxidizing inorganic acid as well as the temperature of the oxidizing inorganic oxidizing acid may influence the oxidizing capacity of the inorganic acid. Some plastic materials and/or inks do not show reaction with a diluted inorganic acid but in case the inorganic acid is present in a high concentration, it may act as an oxidizing agent. For instance, certain polymer materials do not show reaction with diluted sulfuric acid whereas highly concentrated sulfuric acid acts as an oxidizing agent. In addition a strong oxidizing inorganic acid has ability to hydrolyze inks including cross-linked inks comprising, for example, acrylic resins.

In case an oxidizing inorganic acid having a standard electrode potential lower than 0.2 V is used, the concentration of the inorganic acid is preferably higher than 40 wt %, more preferably higher than 50 wt %, 60 wt %, 70 wt %, higher than 80 wt %, higher than 90 wt % or higher than 95 wt %.

In preferred methods of this disclosure, the plastic material is contacted with the inorganic oxidizing acid at a temperature of at least 20° C. In particular methods, the plastic material is contacted with the inorganic oxidizing acid at a temperature of at least 50° C., at a temperature of at least 80° C., at a temperature of at least 100° C. It is clear that the temperature should be lower than the melting temperature of the plastic material. To reach the required temperature the oxidizing inorganic acid can be heated.

The method can be conducted under atmospheric pressure, although it is also possibly to conduct the method under an increased pressure.

It is clear that the method according to this disclosure may comprise the use of more than one oxidizing inorganic acid, for example, by contacting the plastic material first with a first oxidizing inorganic acid (e.g., sulphuric acid) and subsequently with a second oxidizing inorganic acid (e.g., nitric acid).

Preferred methods according to this disclosure further comprise the steps of:
contacting the plastic material with a fatty acid, the fatty acid being a short chain fatty acid having less than 6 carbon atoms or a medium chain fatty acid having 6 until 12 carbon atoms, and
optionally, separating the obtained plastic material from the fatty acid,

whereby the step of contacting the plastic waste with the fatty acid is applied either before the step of contacting the plastic material with the oxidizing inorganic acid or after the separation of the plastic material from the oxidizing inorganic acid.

The method using the combination of an oxidizing inorganic acid and a fatty acid is, in particular, suitable to delaminate and deink plastic material, for example, plastic waste.

For the purpose of this disclosure the term ‘fatty acid’ refers to organic carboxylic acids having an aliphatic chain. The aliphatic chain can be saturated or unsaturated and can be branched or unbranched.

The term ‘short chain fatty acid’ refers to fatty acids having an aliphatic chain of less than 6 carbon atoms. Short chain fatty acids comprise, for example, formic acid, acetic acid, propionic aid, butyric acid, isobutyric acid and isovaleric acid.

The term ‘medium chain fatty acid’ refers to fatty acids having an aliphatic chain having 6 to 12 carbon atoms. Medium chain fatty acids comprise, for example, caproic acid, caprylic acid, caprice acid and lauric acid.

In preferred methods according to this disclosure, the fatty acid comprises a short chain fatty acid. In a particular preferred method the fatty acid comprises formic acid.

A method combining the treatment with an oxidizing inorganic acid and a fatty acid according to this disclosure allows to delaminate and deink plastic material. A method combining the treatment with an oxidizing and a fatty acid according to this disclosure also allows recycling of the delaminated and deinked plastic material even for high demanding application. The use of the oxidizing inorganic acid and the fatty acid allows to delaminate and deink a wide variety of plastic materials and/or plastic material comprising a wide variety of inks, for example, solvent-based inks, water based inks, offset inks, UV and/or EB curable inks and any combination thereof.

Furthermore, a method combining the treatment with an oxidizing inorganic acid and a fatty acid according to this disclosure allows to delaminate and deink a wide variety of combinations of different plastic materials, for example, multilayer plastic materials. A method combining the treatment with an oxidizing inorganic acid and a fatty acid according to this disclosure is, in particular, suitable for use to delaminate and deink plastic waste, in particular, a mix of plastic waste comprising different polymer materials, different combinations of polymer materials, comprising multilayer plastic materials and comprising different types of inks and/or other additives. A method combining the treatment with an oxidizing inorganic acid and a fatty acid according to this disclosure also allows to deink multilayer plastic material even when the ink is not on top of the structure but between different plastic layers.

Although the applicant does not want to be bound by any theory, the main function of the treatment with the short or medium chain fatty acid is delamination of the different layers of a multilayer structure and the main function of the treatment with the oxidizing inorganic acid is to oxidize the inks, preferably including the resin of the inks such as nitrocellulose and/or to hydrolyze the inks, including cross-linked structures such as acrylates.

For the treatment with the fatty acid, the fatty acid is preferably present in a concentration of at least 20 wt %. Preferably, the concentration of the fatty acid ranges between 20 wt % and 100 wt % and is, for example, 40 wt %, 50 wt %, 60 wt %, 70 wt %, 80 wt %, 90 wt % or 95 wt %.

The plastic material is preferably contacted with the fatty acid at a temperature of at least 20° C. More preferably, the plastic material is contacted with the fatty acid at a temperature of at least 50° C., at a temperature of at least 80° C. or at a temperature of at least 100° C. To reach the required temperature the fatty acid can be heated. It is clear that the temperature should be lower than the melting temperature of the plastic material.

The method can be conducted under atmospheric pressure, although it is also possibly to conduct the method under an increased pressure.

The process can furthermore be improved by applying shear on the plastic material while or after contacting the plastic material with the fatty acid and/or by applying shear on the plastic material while or after contacting the plastic material with the oxidizing inorganic acid. As described above shear can be applied by any method known in the art, for example, by stirring, mixing or agitating.

In preferred methods, the plastic material is reduced in size, preferably before being contacted with the fatty acid and/or before being contacted with the oxidizing inorganic acid. In case the plastic material is first contacted with the oxidizing inorganic acid, the plastic material is preferably reduced in size before being contacted with the oxidizing inorganic acid. In case the plastic material is first contacted with the fatty acid, the plastic material is preferably reduced in size before being contacted with the fatty acid.

As described above the reduction in size can be obtained by any technique known in the art, for example, by milling, shredding, grinding and/or comminuting. The plastic material is preferably reduced in size to obtain plastic material having a sieve diameter between 0.01 cm and 20 cm, for example, between 0.01 cm and 10 cm or between 0.1 cm and 4 cm.

Preferably, during the contacting of the plastic material with the fatty acid, the loading of the plastic material over the volume of the fatty acid expressed as the volume of the plastic material Vₚₘ over the volume of the fatty acid V_{fatty acid}, the ratio

$$( \frac{{V}_{p m}}{{V}_{fatty acid}} ) ,$$

is at least 0.001. The ratio

$$\frac{{V}_{p m}}{{V}_{fatty acid}}$$

is, for example, at least 0.01 or at least 0.1. The ratio

$$\frac{{V}_{p m}}{{V}_{fatty acid}}$$

is, for example, ranging between 0.001 and 1, between 0.001 and 0.5 or between 0.001 and 0.1.

In a first preferred method according to this disclosure the plastic material such as the plastic waste is first treated with a fatty acid and subsequently with an oxidizing inorganic acid.

Such method comprises, for example, the following steps:
a) providing plastic material, for example, plastic waste, comprising or provided with an ink selected from the group comprising resins based comprising or provided with an ink selected from the group comprising nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, (phenolic) modified rosin based resins, alkyd based resins and any combination thereof;
b) contacting the plastic material with a fatty acid, wherein the fatty acid comprises a short chain fatty acid having less than 6 carbon atoms or a medium chain fatty acid having 6 until 12 carbon atoms;
c) separating the plastic material obtained in step b) from the fatty acid;
d) contacting the plastic material obtained in step c) with an oxidizing inorganic acid having a standard electrode potential of at least 0 V; and
e) separating the plastic material obtained in step d) from the oxidizing inorganic acid.

This method is, in particular, suitable to delaminate and deink plastic material, for example, plastic waste, comprising multilayered structures. More particularly, the method is suitable to delaminate and deink plastic material comprising multilayered structures having ink between successive layers of the multilayered structure.

In a particular preferred method the plastic material is contacted with a short chain fatty acid in step b) and contacted with an oxidizing oxyacid in step d), for example, contacted with formic acid in step b) and with nitric acid or sulfuric acid in step d).

Deinking can be further improved by applying shear on the plastic material while or after contacting the plastic material with the fatty acid and/or while or after contacting the plastic material with the oxidizing acid. As described above shear can be applied by any method known in the art, for example, by stirring, mixing or agitating.

In preferred methods, the plastic material is reduced in size, preferably before being contacted with the fatty acid and/or before being contacted with the oxidizing inorganic acid. As described above the reduction in size can be obtained by any technique known in the art, for example, by milling, shredding, grinding and/or comminuting. The plastic material is preferably reduced in size to obtain plastic material having a sieve diameter between 0.01 cm and 20 cm, for example, between 0.01 cm and 10 cm or between 0.1 cm and 4 cm.

In preferred methods of this disclosure, during the contacting of the plastic material with the oxidizing inorganic acid, the plastic material and the oxidizing inorganic acid are present in amounts so that the volume of the plastic material (Vₚₘ) over the volume of the oxidizing inorganic acid (V_{acid}) is ranging between 0.1 and 10, more preferably between 0.5 and 2.5 or between 0.8 and 1.2.

In a second preferred method according to this disclosure the plastic material such as the plastic waste is first treated with an oxidizing inorganic acid and subsequently with a fatty acid.

Such method comprises, for example, the following steps:
a) providing plastic material, for example, plastic waste, comprising or provided with an ink selected from the group comprising resins based comprising or provided with an ink selected from the group comprising nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, (phenolic) modified rosin based resins, alkyd based resins and any combination thereof;
b) contacting the plastic material with an oxidizing inorganic acid having a standard electrode potential of at least 0 V;
c) separating the plastic material obtained in step b) from the oxidizing inorganic acid;
d) contacting the plastic material obtained in step c) with a fatty acid, wherein the fatty acid comprises a short chain fatty acid having less than 6 carbon atoms or a medium chain fatty acid having 6 until 12 carbon atoms; and
e) separating the plastic material obtained in step d) from the fatty acid.

This method is, in particular, suitable to delaminate and deink plastic material, for example, plastic waste comprising multilayered structures. More particularly the method according to this disclosure is suitable to delaminate and deink plastic material comprising multilayered structures having ink on top of the multilayered structure.

In a particular preferred method the plastic material is contacted with an oxidizing oxyacid in step b) and contacted with a short chain fatty acid in step d), for example, contacted with nitric acid or sulfuric acid in step b) and with formic acid in step d).

Deinking can be further improved by applying shear on the plastic material while or after contacting the plastic material with the oxidizing inorganic acid and/or while or after contacting the plastic material with the fatty acid. As described above shear can be applied by any method known in the art, for example, by stirring, mixing or agitating.

In preferred methods, the plastic material is reduced in size, preferably before being contacted with the oxidizing inorganic acid and/or before being contacted with the fatty acid. As described above the reduction in size can be obtained by any technique known in the art, for example, by milling, shredding, grinding and/or comminuting. The plastic material is preferably reduced in size to obtain plastic material having a sieve diameter between 0.01 cm and 20 cm, for example, between 0.01 cm and 10 cm or between 0.1 cm and 4 cm.

In preferred methods of this disclosure, during the contacting of the plastic material with the oxidizing inorganic acid, the plastic material and the oxidizing inorganic acid are present in amounts so that the volume of the plastic material (Vₚₘ) over the volume of the oxidizing inorganic acid (V_{acid}) is ranging between 0.1 and 10, more preferably between 0.5 and 2.5 or between 0.8 and 1.2.

In further preferred methods according to this disclosure, the plastic material can be treated in a method using more than one oxidizing inorganic acid and/or more than one fatty acid.

The plastic material, such as the plastic waste is, for example, first treated with a first fatty acid, followed by a treatment with an oxidizing inorganic acid and a treatment with a second fatty acid.

Such method comprises the following steps:
a) providing plastic material, for example, plastic waste, comprising or provided with an ink selected from the group comprising resins based comprising or provided with an ink selected from the group comprising nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, (phenolic) modified rosin based resins, alkyd based resins and any combination thereof;
b) contacting the plastic material with a first fatty acid; wherein the first fatty acid comprises a short chain fatty acid having less than 6 carbon atoms or a medium chain fatty acid having 6 until 12 carbon atoms;
c) separating the plastic material obtained in step b) from the first fatty acid;
d) contacting the plastic material obtained in step c) with an oxidizing inorganic acid having a standard electrode potential of at least 0 V;
e) separating the plastic material obtained in step d) from the oxidizing inorganic acid;
f) contacting the plastic material obtained in step e) with a second fatty acid, wherein the second fatty acid comprises a short chain fatty acid having less than 6 carbon atoms or a medium chain fatty acid having 6 until 12 carbon atoms; and
g) separating the plastic material obtained in step f) from the second fatty acid.

It is clear that the first and the second fatty acid may comprise the same fatty acid or different fatty acids. The first fatty acid comprises, for example, formic acid and the second fatty acid comprises, for example, acetic acid.

This method is, in particular, suitable for plastic material, for example, plastic waste, comprising a wide variety of plastics, for example, a wide variety of multilayered structures having ink on top of the multilayered structure and/or ink between successive layers of the multilayered structure.

In a particular preferred method the plastic material is contacted with formic acid in step b), with nitric acid or sulfuric acid in step d) and contacted with formic acid in step f).

It is clear that the method using contacting steps with two fatty acids (respectively, with a first fatty acid and a second fatty acid) may comprise one or more steps to apply shear on the plastic material while or after contacting with the oxidizing inorganic acid and/or while or after contacting the plastic material with the first and/or second fatty acid and/or one or more steps to reduce the plastic material in size, preferably before being contacted with the oxidizing inorganic acid and/or before being contacted with the first and/or second fatty acid.

It is clear that in a method using contacting steps with two fatty acids (respectively, with a first fatty acid and second fatty acid), it can be preferred that the plastic material and the oxidizing inorganic acid are present in amounts so that the volume of the plastic material (Vₚₘ) over the volume of the oxidizing inorganic acid (V_{inorg. acid}) is ranging between 0.1 and 10, more preferably between 0.5 and 2.5 or between 0.8 and 1.2.

In still a further method according to this disclosure the plastic material such as the plastic waste is first treated with a first oxidizing inorganic acid, followed by a treatment with a fatty acid and a treatment with a second oxidizing inorganic acid.

Such method comprises the following steps:
a) providing plastic material, for example, plastic waste, comprising or provided with an ink selected from the group comprising resins based comprising or provided with an ink selected from the group comprising nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, (phenolic) modified rosin based resins, alkyd based resins and any combination thereof;
b) contacting the plastic material with a first oxidizing inorganic acid having a standard electrode potential of at least 0 V;
c) separating the plastic material obtained in step b) from the first oxidizing inorganic acid;
d) contacting the plastic material obtained in step c) with a fatty acid, wherein the fatty acid comprises a short chain fatty acid having less than 6 carbon atoms or a medium chain fatty acid having 6 until 12 carbon atoms;
e) separating the plastic material obtained in step d) from the fatty acid;
f) contacting the plastic material obtained in step e) with a second oxidizing inorganic acid having a standard electrode potential of at least 0 V; and
g) separating the plastic material obtained in step f) from the second oxidizing inorganic acid.

It is clear that the first and the second inorganic acid may comprise the same oxidizing inorganic acid or different oxidizing inorganic acids. The first oxidizing inorganic acid comprises, for example, sulfuric acid and the second oxidizing inorganic acid comprises, for example, nitric acid.

This method is, in particular, suitable for plastic material, for example, plastic waste, comprising a wide variety of plastics, for example, a wide variety of multilayered structures having ink on top of the multilayered structure and/or ink between successive layers of the multilayered structure.

In a particular preferred method the plastic material is contacted with sulfuric acid in step b), with formic acid in step d) and contacted with sulfuric acid or nitric acid in step f).

It is clear that the method using contacting steps with two oxidizing inorganic acids (respectively, with a first oxidizing inorganic acid and a second oxidizing inorganic acid) may comprise one or more steps to apply shear on the plastic material while or after contacting with the first and/or second oxidizing inorganic acid and/or while or after contacting the plastic material with the acid and/or one or more steps to reduce the plastic material in size, preferably before being contacted with the first and/or second oxidizing inorganic acid and/or before being contacted with the fatty acid.

It is clear that in a method using contacting steps with two oxidizing inorganic acids (respectively, with a first oxidizing inorganic acid and second oxidizing inorganic acid), it can be preferred that the plastic material and the first oxidizing inorganic acid are present in amounts so that the volume of the plastic material (Vₚₘ) over the volume of the first inorganic oxidizing inorganic acid (V_{1st inorg. acid}) is ranging between 0.1 and 10, more preferably between 0.5 and 2.5 or between 0.8 and 1.2 and/or that the plastic material and the second oxidizing inorganic acid are present in amounts so that the volume of the plastic material (Vₚₘ) over the volume of the first inorganic oxidizing inorganic acid (V_{2nd inorg. acid}) is ranging between 0.1 and 10.

The method according to this disclosure may comprise one or more additional steps. Any method described above may comprise such one or more additional steps.

Such additional steps may comprise one or more conditioning steps, one or more polymer sorting steps, one or more comminuting steps, one or more steps to recover the inorganic acid and/or the fatty acid, one or more steps to recover inks and/or plastic layers, one or more solvent recovery steps, one or more rinsing or washing steps, for example, to remove acid remnants, and/or one or more drying steps.

An example of a conditioning step comprises steps to remove paper or cardboard.

Examples of comminuting steps comprise cutting, shredding, milling and/or grinding.

Polymer sorting steps comprise, for example, steps using wind shifting, density separation and/or near infra-red (NIR) separation.

Recovery steps of, for example, inks or solvents comprise, for examples, steps using membrane technologies, adsorption technologies and/or distillation.

The method according to this disclosure may comprise a continuous process or a batch process.

According to a second aspect of this disclosure an installation to deink plastic material is provided. The installation comprises means to provide plastic material, means to provide an oxidizing inorganic acid and means to bring the oxidizing inorganic acid in contact with the plastic material. The installation may further comprise means to rinse the plastic material and/or means to dry the plastic material. Optionally, the installation to deink plastic material further comprises means to condition the plastic material, for example, means to remove paper or cardboard, means for comminuting the plastic material, means to recover the inorganic acid and/or the fatty acid, means to recover inks and/or plastic layers, means to recover solvent, means for rinsing or washing and/or for removing acid remnants and/or means to dry the plastic material. The installation is suitable to deink plastic material such as plastic waste.

A preferred installation further comprises means to provide a fatty acid and means to bring the fatty acid in contact with the plastic material. Such installation comprising means to provide a fatty acid, means to bring the fatty acid in contact with the plastic material, means to provide an oxidizing inorganic acid and means to bring the oxidizing inorganic acid in contact with the plastic material is, in particular, suitable to deink plastic material such as plastic waste, in particular, plastic material having the ink at the top layer of the plastic material or having the ink between successive layers. In particular, such installation is suitable to delaminate and deink plastic material, for example, multilayer plastic material.

### BRIEF DESCRIPTION OF THE DRAWINGS

This disclosure will be discussed in more detail below, with reference to the attached drawings, in which:

FIG. 1A shows the deinking rate of different types of plastic packaging films after treatment using a method according to this disclosure using sulfuric acid with a time span of 0 until 300 seconds;

FIG. 1B shows a detail of FIG. 1A with a time span of 0 until 30 seconds;

FIG. 2 shows the deinking rate of different types of plastic packaging films after treatment using a method using ethyl acetate;

FIG. 3 shows the deinking rate of different types of plastic packaging films after treatment using a method using cetrimonium bromide (hexadecytrimethylammoniumbromid) (CTAB);

FIG. 4 shows the saturation point of three different tested deinking methods; and

FIG. 5 shows the deinking time using different ratios of volume of plastic over the volume of the oxidizing inorganic acid (referred to as washing medium) at the following conditions: 55% H₂SO₄ as deinking medium, in a batch reactor with volume of 1 L, stirred with an agitator at 600 rpm, at 25° C.

### DETAILED DESCRIPTION

This disclosure will be described with respect to particular embodiments and with reference to certain drawings but the disclosure is not limited thereto but only by the claims. The drawings are only schematic and are non-limiting. The size of some of the elements in the drawing may be exaggerated and not drawn on scale for illustrative purposes. The dimensions and the relative dimensions do not correspond to actual reductions to practice of the disclosure.

When referring to the endpoints of a range, the endpoints values of the range are included.

When describing the disclosure, the terms used are construed in accordance with the following definitions, unless indicated otherwise.

The term ‘and/or’ when listing two or more items, means that any one of the listed items can by employed by itself or that any combination of two or more of the listed items can be employed.

The terms ‘first,’ ‘second’ and the like used in the description as well as in the claims, are used to distinguish between similar elements and not necessarily describe a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

### EXAMPLES AND EXPERIMENTAL RESULTS

### Example 1

A multilayer plastic packaging film comprising a PET layer, a solvent-based ink, a polyurethane-based adhesive, and a white PE layer, in this sequence, was reduced in size by a shredder with a sieve diameter of 2.38 mm. The obtained particles were brought into contact with formic acid under continuous stirring with an agitator at 500 rpm. The formic acid has a concentration of 99.9 w/w %. The volume of the plastic material over the volume of formic acid was 0.001. 100% delamination was obtained in 20 seconds. The delamination percentage was measured by quantifying the absorbance of some defined peaks of the present tie layer. Thereafter, the delaminated polymers were deinked through interaction with sulfuric acid at 70° C. under continuous stirring with an agitator at 350 rpm. The volume of the plastic material over the volume of sulfuric acid was 0.1. The sulfuric acid has a concentration of 96.0 w/w %. 100% deinking was obtained in 5 seconds. The deinking percentage was measured via an optical-based technique, quantifying the optical density of the sample.

### Example 2

A plastic packaging film comprising a transparent oriented polypropylene (OPP) layer, a nitrocellulose/polyurethane resin, and a solvent-based black ink layer, respectively, was reduced in size by a shredder with a sieve diameter of 2.38 mm. The obtained particles were brought into contact with sulfuric acid at 70° C. under continuous stirring with an agitator at 250 rpm. The volume of the plastic material over the volume of sulfuric acid was 0.1. The sulfuric acid has a concentration of 80 w/w %. 100% deinking was obtained in 90 seconds.

### Example 3

A multilayer plastic packaging film comprising a PET layer, a solvent-based ink, a polyurethane-based adhesive, an aluminum layer, another polyurethane-based adhesive, and a PP layer in this sequence, was reduced in size by a shredder with a sieve diameter of 2.38 mm. The obtained particles were brought into contact with formic acid at 100° C. under continuous stirring with an agitator at 100 rpm. The formic acid has a concentration of 75 w/w %. The volume of the plastic material over the volume of formic acid was 0.001. 100% delamination was obtained in 100 seconds. Thereafter, these delaminated polymers can be deinked with an oxidizing inorganic acid, as disclosed in this disclosure.

### Example 4

A plastic packaging film comprising a transparent OPP substrate, a cross-linked acrylate resin, a UV-based white ink layer, and a cyan ink layer as top layer, was reduced in size by a shredder with a sieve diameter of 2.38 mm. The obtained particles were brought into contact with sulfuric acid at 25° C. under continuous stirring with an agitator at 250 rpm. The volume of the plastic material over the volume of sulfuric acid was 0.1. The sulfuric acid has a concentration of 96.0 w/w %. 100% deinking was obtained in 45 seconds.

### Example 5

A plastic packaging film comprising a PE layer, an ethylene vinyl alcohol (EVOH) layer, a PET layer, and a water-based red ink layer, in this sequence, was reduced in size by a shredder with a sieve diameter of 20 mm. The obtained particles were brought into contact with nitric acid at 25° C. under continuous stirring with an agitator at 250 rpm. The volume of the plastic material over the volume of nitric acid was 0.1. The nitric acid has a concentration of 70.0 w/w %. 100% deinking was obtained in 300 seconds.

Comparison of the Method According to this Disclosure with Existing Deinking Processes

The deinking rate of 7 different types of plastic packaging materials (referred to as plastic 1 to plastic 7) using three different deinking methods (referred to as method A to C) is compared.

The composition of the 7 types of plastic packaging material (type of ink, resin, substrate and varnish) is described below.

The tested plastic packaging materials comprise:
1 PE films with solvent-based cyan ink and a varnish layer
2 PE film with solvent-based black ink
3 OPP film with solvent-based white ink, cyan ink and a varnish layer
4 OPP film with water-based cyan ink
5 OPP film with water-based white ink and cyan ink
6 OPP film with UV-based cyan ink
7 OPP film with UV-based cyan ink and a varnish layer

The three different deinking methods are described below:
Method A comprises a method according to this disclosure in which the plastic packaging material is brought in contact with sulfuric acid (concentration 96.0 w/w %) at 70° C. under continuous stirring with an agitator at 250 rpm.
Method B the plastic is brought in contact with ethyl acetate (concentration 99.8 w/w %) at 77° C. under continuous stirring with an agitator at 250 rpm.
Method C the plastic is brought in contact with a surfactant, in this case cetrimonium bromide (CTAB) with a concentration of 10 mM at 80° C. under continuous stirring with an agitator at 250 rpm.

Method B and Method C are methods known in the prior art as deinking methods, respectively described in DE19651571A1 and EP2832459A1.

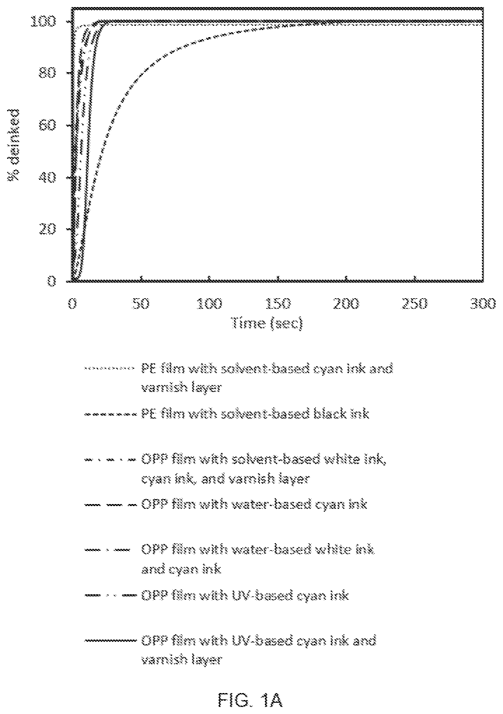

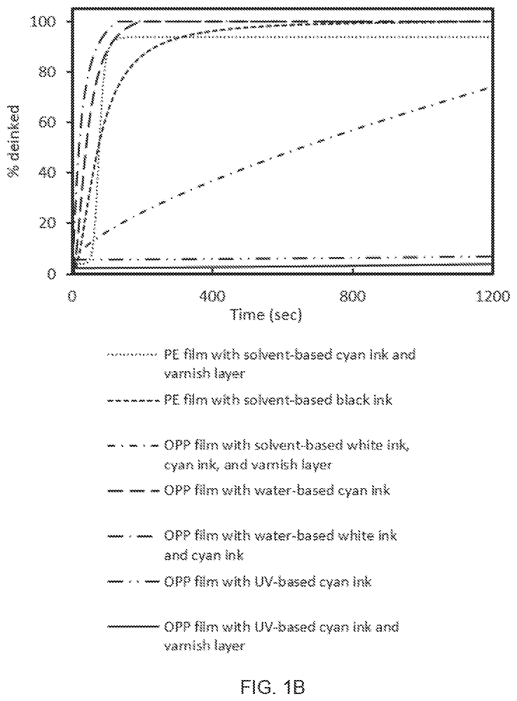

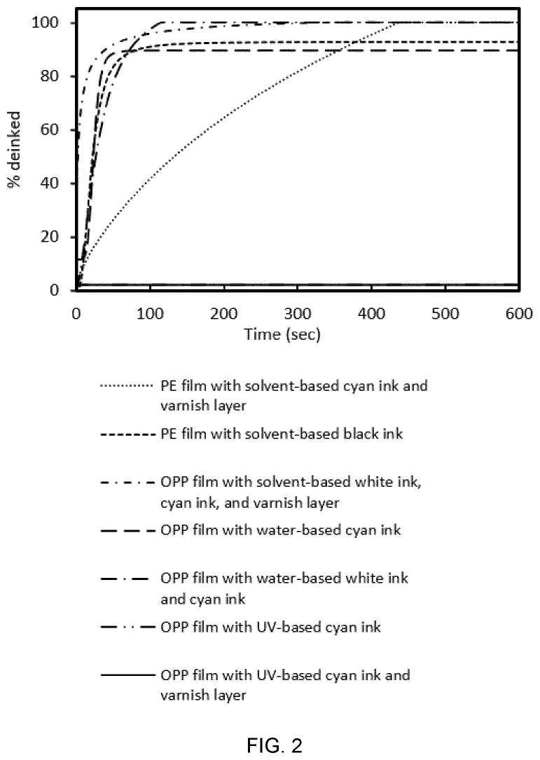

The deinking rates of the different packaging materials of method A are shown in FIG. 1A (with a time span of 0 until 300 seconds) and FIG. 1B (with a time span of 0 until 30 seconds). The deinking rates of the different packaging materials of method B and method C are respectively shown in FIG. 2 (with a time span of 0 until 600 seconds) and FIG. 3 (with a time span of 0 until 1200 seconds).

A comparison of the three deinking methods shows that only the method according to this disclosure (Method A, using sulfuric acid, as an oxidizing inorganic acid) is able to deink all types of plastic films. Moreover, the method according to this disclosure (Method A) deinks all types of films faster compared to the other deinking methods.

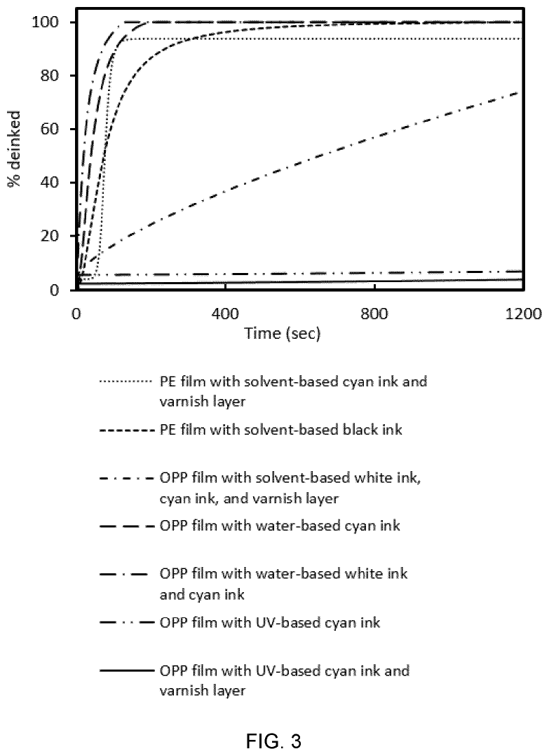

FIG. 4 indicates the saturation points of the three tested deinking methods, measured by determining the amount of fully printed films with a size of 2.8 cm×3.5 cm that could be deinked completely in 100 mL of liquid medium. The results show that sulfuric acid has a much higher saturation point compared to ethyl acetate and CTAB. While with ethyl acetate (at a concentration of 99.5 w/w %, a temperature of 77° C., and an agitation speed of 250 RPM) and CTAB (at a concentration of 0.009 mol/L (=10×CMC), a temperature of 25° C., and an agitation speed of 250 RPM) less than 0.5 cm² of a fully printed monolayer packaging film can be deinked per mL of solvent, with sulfuric acid (at a concentration of 96.0 w/w %, a temperature of 70° C., and an agitation speed of 200 RPM) around 30 cm² of a fully printed monolayer packaging film per mL can be deinked.

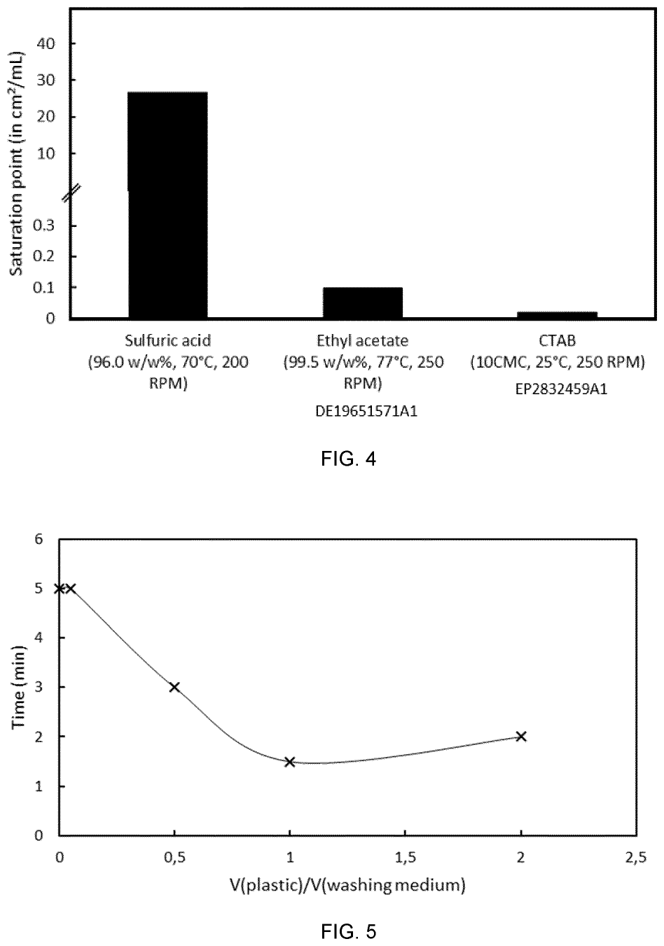

FIG. 5 shows the deinking time using different ratios of volume of plastic over the volume of the oxidizing inorganic acid (referred to as washing medium) at the following conditions: 55% H₂SO₄ as deinking medium, in a batch reactor with volume of 1 L, stirred with an agitator at 600 rpm, at 25° C. The deinking time was determined by visual inspection and using video-based analysis.

1. A method to deink plastic material, the method comprising the steps of
providing plastic material comprising or provided with an ink selected from the group consisting of nitrocellulose based resins, polyurethane based resins, polyvinylchloride based resins, ethyl cellulose based resins, cellulose acetate propionate based resins, cellulose acetate butyrate based resins, polyvinyl butyral based resins, acrylate based resins, polyacrylate based resins, polyamide based resins, maleics based resins, modified rosin based resins, alkyd based resins and any combination thereof;
contacting the plastic material with an oxidizing inorganic acid having a standard electrode potential of at least 0 V; and
separating the thus obtained plastic material from the oxidizing inorganic acid.

2. The method according to claim 1, wherein shear is applied to the plastic material before or while contacting the plastic material with the oxidizing inorganic acid.

3. The method according to claim 1, wherein the plastic material is reduced in size to obtain plastic material having a sieve diameter ranging between 0.01 cm and 20 cm before being contacting the plastic material with the oxidizing inorganic acid.

4. The method according to claim 1, wherein during the contacting of the plastic material with the oxidizing inorganic acid the volume of plastic material over the volume of the oxidizing inorganic acid ranges between 0.1 and 10.

5. The method according to claim 1, wherein the oxidizing inorganic acid comprises an oxyacid.

6. The method according to claim 1, wherein the oxidizing inorganic acid is selected from the group consisting of HNO₃, H₂SO₄, HClO₄, H₂CrO₄, H₂SeO₄, HMnO₄, HTcO₄, HReO₄, H₃PO₄, H₃AsO₄, H₂TeO₄, HBrO₄ and HIO₄.

7. The method according to claim 1, wherein the oxidizing inorganic acid contacting the plastic material is present in a concentration of at least 20 wt %.

8. The method according to claim 1, wherein the plastic material is contacted with the oxidizing inorganic acid at a temperature of at least 20° C.

9. The method according to claim 1, wherein the method further comprises the step of
contacting the plastic material with a fatty acid, the fatty acid being a short chain fatty acid having less than 6 carbon atoms or a medium chain fatty acid having 6 until 12 carbon atoms; and
optionally, separating the obtained plastic material from the fatty acid,
whereby the step of contacting the plastic material with the fatty acid is applied either before the step of contacting the plastic material with the oxidizing inorganic acid or after the separation of the plastic material from the oxidizing inorganic acid.

10. The method according to claim 9, wherein during the contacting of the plastic material with the fatty acid the volume of plastic material over the volume of the fatty acid is at least 0.001.

11. The method according to claim 9, wherein the short chain fatty acid is selected from the group consisting of formic acid, acetic acid, propionic acid, butyric acid, isobutyric acid, valeric acid, isovaleric acid and the medium chain fatty acid is selected from the group consisting of caproic acid, caprylic acid, capric acid and lauric acid.

12. The method according to claim 9, wherein the short chain fatty acid or the medium chain fatty acid contacting the plastic material is present in a concentration of at least 20 wt %.

13. The method according to claim 9, wherein the plastic material is contacted with the fatty acid at a temperature of at least 20° C.

14. The method according to claim 9, wherein the plastic material comprises monolayer and/or multilayer plastic material.

15. (canceled)

16. The method according to claim 10, wherein
the short chain fatty acid is selected from the group consisting of formic acid, acetic acid, propionic acid, butyric acid, isobutyric acid, valeric acid, isovaleric acid, and
the medium chain fatty acid is selected from the group consisting of caproic acid, caprylic acid, capric acid, and lauric acid.

17. The method according to claim 10, wherein the short chain fatty acid or the medium chain fatty acid contacting the plastic material is present in a concentration of at least 20 wt %.

18. The method according to claim 11, wherein the short chain fatty acid or the medium chain fatty acid contacting the plastic material is present in a concentration of at least 20 wt %.

19. The method according to claim 16, wherein the short chain fatty acid or the medium chain fatty acid contacting the plastic material is present in a concentration of at least 20 wt %.

20. The method according to claim 10, wherein the plastic material is contacted with the fatty acid at a temperature of at least 20° C.

21. The method according to claim 11, wherein the plastic material is contacted with the fatty acid at a temperature of at least 20° C.
